(19) United States
(12) Patent Application Publication
(10) Pub. No.: US 2025/0105344 A1
(43) Pub. Date: Mar. 27, 2025

(54) SOLID-STATE BATTERY WITH ENHANCED SOLID ELECTROLYTE

(71) Applicant: Microsoft Technology Licensing, LLC, Redmond, WA (US)

(72) Inventors: Chi CHEN, Renton, WA (US); Nathan Andrew BAKER, Kennewick, WA (US); Brian Allen BILODEAU, Redmond, WA (US); Matthias TROYER, Zurich (CH); Craig Daniel OWEN, Sammamish, WA (US); Linda Shieh-You LAUW, Bellevue, WA (US)

(21) Appl. No.: 18/669,352

(22) Filed: May 20, 2024

Related U.S. Application Data
(60) Provisional application No. 63/539,990, filed on Sep. 22, 2023.

(51) Int. Cl. H01M 10/0562; H01M 10/0525; H01M 10/054

(52) U.S. Cl. CPC H01M 10/0562; H01M 10/0525; H01M 10/054; H01M 2300/008

(57) ABSTRACT

Disclosed herein is a solid-state battery comprising an anode, cathode, and solid electrolyte disposed between and in conductive contact with the anode and the cathode. The solid electrolyte comprises the compound NaₓLi₃₋ₓYCl₆ (0<x<3), which can have a trigonal ordered crystal structure. The solid-state battery can be configured as a lithium-ion battery or as a sodium-ion battery.

### CROSS-REFERENCE TO RELATED APPLICATIONS

This application claims priority to and the benefit of U.S. Provisional Application No. 63/539,990, filed Sep. 22, 2023 and titled “Solid-State Battery with Enhanced Solid Electrolyte,” the entirety of which is incorporated herein by reference.

### STATEMENT REGARDING GOVERNMENT INTEREST

This invention was made with government support under DE-AC05-76RL01830 awarded by the U.S. Department of Energy to Battelle Memorial Institute, Pacific Northwest Division, operator of the Pacific Northwest National Laboratory (PNNL). The government has certain rights in the invention pursuant to Research & Development Services Agreement 81614 between Applicant and Battelle Memorial Institute, Pacific Northwest Division.

### BACKGROUND

Lithium-ion batteries are commonly used to power electronic devices. Standard lithium-ion batteries include liquid electrolytes. These liquid electrolytes are conventionally comprised of flammable liquid organic compounds. In cases of over-charging or short circuiting, for example, a conventional lithium-ion battery with a liquid electrolyte can become a safety and fire hazard.

Solid-state lithium-ion batteries can potentially provide improvements over conventional liquid electrolyte lithium-ion batteries, such as better safety, thermal stability, energy density, power density, and/or a broader working temperature range relative to conventional lithium-ion batteries. However, several challenges remain in developing effective and widely adoptable solid-state lithium-ion batteries. In particular, there is an ongoing need for solid electrolytes that can function effectively when used in solid-state lithium-ion batteries.

### SUMMARY

Disclosed herein is the compound:

NaₓLi₃₋ₓYCl₆

wherein x is greater than 0 and less than 3, such as wherein x is greater than 0.5 and less than 2.5. Examples include Na₂LiYCl₆, NaLi₂YCl₆, Na_{0.5}Li_{2.5}YCl₆, Na_{1.5}Li_{1.5}YCl₆, and Na_{2.5}Li_{0.5}YCl₆. The disclosed compound is usable as an effective solid-state battery electrolyte. The disclosed compound can have a trigonal ordered crystal structure, such as with an R3̅ or P3̅m1 space group. The disclosed compound can exhibit characteristics beneficial for solid-state battery electrolyte applications. Such characteristics include, for example, effective ionic conductivity (including room temperature conductivity), formability/ductility, oxidation/reduction stability, and compatibility with anode and cathode materials.

Also disclosed herein is a solid electrolyte comprising the compound NaₓLi₃₋ₓYCl₆ (0<x<3). The disclosed compound, as used in the solid electrolyte, can have a trigonal ordered crystal structure. Also disclosed herein is a solid-state battery that includes the solid electrolyte comprising the compound NaₓLi₃₋ₓYCl₆ (0<x<3). The solid electrolyte can beneficially function to conduct lithium ions and sodium ions. The solid-state battery can therefore be configured as a lithium-ion battery, a sodium-ion battery, or a dual ion battery.

Also disclosed herein is a method of manufacturing a solid-state battery, such as a solid-state lithium-ion battery or a solid-state sodium-ion battery. The method comprises: placing a positive electrode within a container; placing a negative electrode within the container; and placing a solid electrolyte within the container between and in conductive contact with the positive electrode and the negative electrode, wherein the solid electrolyte comprises NaₓLi₃₋ₓYCl₆ (0<x<3). The NaₓLi₃₋ₓYCl₆ (0<x<3) compound optionally comprises a trigonal ordered crystal structure.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1A is a schematic view of an example solid-state lithium-ion battery during discharge;

FIG. 1B is a schematic view of the example solid-state lithium-ion battery during charge;

FIG. 2A is a schematic view of an example solid-state sodium-ion battery during discharge; and

FIG. 2B is a schematic view of the example solid-state sodium-ion battery during charge.

FIG. 3 shows powder x-ray diffraction (XRD) results of various tested NaₓLi₃₋ₓYCl₆ samples.

FIG. 4 shows atomic percentages of Na, Li, Y, and Cl from the XPS analysis

FIG. 5 shows ionic conductivities of various tested NaₓLi₃₋ₓYCl₆ samples measured at different temperatures.

FIG. 6 shows ionic conductivities and activation energy of various tested NaₓLi₃₋ₓYCl₆ samples.

### DETAILED DESCRIPTION

### Introduction

The three principal functional components of a lithium-ion battery are the positive electrode, negative electrode, and electrolyte. The “negative electrode” often includes lithium metal intercalated with layers of graphite, and the “positive electrode” often includes a lithium-metal oxide intercalated with the layers of metal oxide. The electrochemical roles of the electrodes reverse between anode and cathode, depending on the direction of current flow through the cell. Often, the designation of anode and cathode are made in reference to their functions during discharge. Accordingly, unless specified otherwise, the terms anode and cathode will refer to designations corresponding to discharge.

During discharge, lithium metal at the anode is oxidized in an oxidation half reaction to generate lithium ions and electrons. The electrons pass through the circuit while the generated lithium ions pass through the electrolyte toward the cathode. At the cathode, the lithium ions that have passed through the electrolyte are combined with metal oxide in a reduction half reaction in which metal species of the metal oxide are reduced by electrons received at the cathode to generate lithium-metal oxide.

The designations of “anode” and “cathode” are technically reversed during recharging of the battery. During recharging, the metal species of the lithium-metal oxide are oxidized to the metal oxide at the “anode,” releasing lithium ions that migrate through the electrolyte to the “cathode” where they are reduced to lithium metal.

Unlike the liquid electrolytes or gel electrolytes used in conventional lithium-ion batteries, a solid-state battery includes a solid electrolyte. Solid-state lithium-ion batteries can potentially provide improvements over conventional liquid electrolyte lithium-ion batteries, including better safety, thermal stability, energy density, power density, and/or a broader working temperature range relative to conventional lithium-ion batteries. However, determining effective solid electrolyte materials is among the challenges in developing effective solid-state lithium-ion batteries.

Disclosed herein is the compound:

NaₓLi₃₋ₓYCl₆

wherein x is greater than 0 and less than 3, such as wherein x is greater than 0.5 and less than 2.5. Examples include Na₂LiYCl₆, NaLi₂YCl₆, Na_{0.5}Li_{2.5}YCl₆, Na_{1.5}Li_{1.5}YCl₆, and Na_{2.5}Li_{0.5}YCl₆. The disclosed compound is usable as an effective solid-state battery electrolyte. The disclosed compound can have a trigonal ordered crystal structure, such as with an R3̅ or a P3̅m1 space group. The disclosed compound can exhibit characteristics beneficial for solid-state battery electrolyte applications. Such characteristics include, for example, effective ionic conductivity (including room temperature conductivity), formability/ductility, oxidation/reduction stability, and compatibility with anode and cathode materials.

A trigonal ordered crystal structure refers to a crystalline structure that falls within the trigonal crystal system (of the seven possible crystal systems) and therefore exhibits three-fold symmetry about a central axis.

Also disclosed herein is a solid electrolyte comprising the compound NaₓLi₃₋ₓYCl₆ (0<x<3). The disclosed compound, as used in the solid electrolyte, can have a trigonal ordered crystal structure. Also disclosed herein is a solid-state battery that includes the solid electrolyte comprising the compound NaₓLi₃₋ₓYCl₆ (0<x<3). The solid electrolyte can beneficially function to conduct lithium ions and sodium ions. The solid-state battery can therefore be configured as a lithium-ion battery or alternatively as a sodium-ion battery.

Also disclosed herein is a method of manufacturing a solid-state battery, such as a solid-state lithium-ion battery or a solid-state sodium-ion battery. The method comprises: placing a positive electrode within a container; placing a negative electrode within the container; and placing a solid electrolyte within the container between and in contact with the positive electrode and the negative electrode, wherein the solid electrolyte comprises NaₓLi₃₋ₓYCl₆ (0<x<3). The NaₓLi₃₋ₓYCl₆ (0<x<3) compound optionally comprises a trigonal ordered crystal structure.

### Solid-State Battery

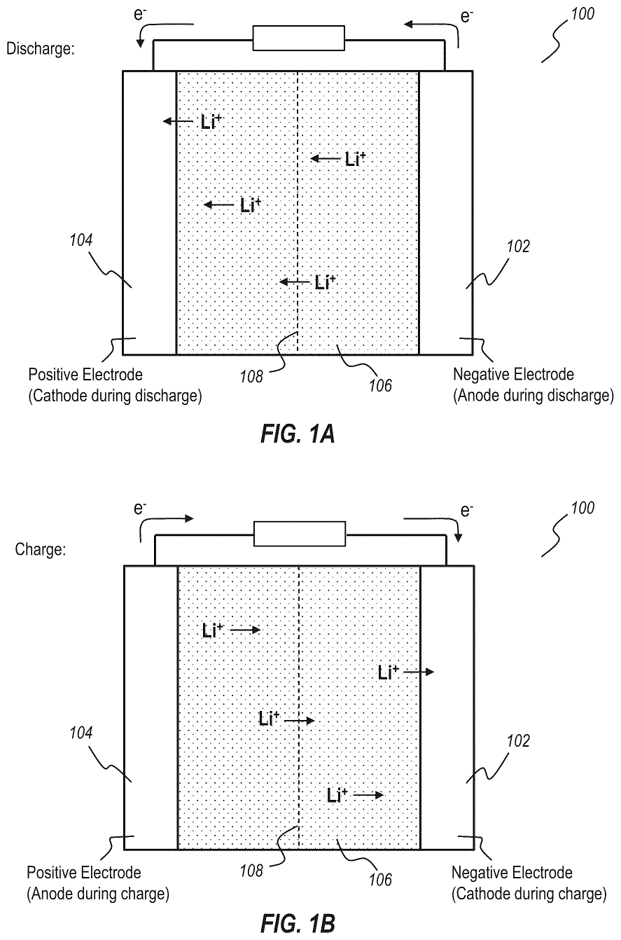

FIG. 1A is a schematic view of an example solid-state lithium-ion battery 100 during discharge, and FIG. 1B is a schematic view of the example solid-state lithium-ion battery 100 during charge.

As shown in FIG. 1A, the oxidation half reaction occurs at the negative electrode 102, generating lithium ions and electrons. The generated lithium ions pass through the solid electrolyte 106 toward the positive electrode 104. At the positive electrode 104, the lithium ions combine with the electrons in the reduction half reaction to form lithium-metal oxide. The battery 100 can also include a separator 108, though in some embodiments the separator 108 can be omitted because the electrolyte 106 is solid.

During charge, the lithium-metal oxide at the positive electrode 104 is oxidized to generate lithium ions and electrons. The generated lithium ions pass through the solid electrolyte 106 toward the negative electrode 104. At the negative electrode 102, the lithium ions combine with the electrons in the reduction half reaction to form lithium metal.

As discussed above, the solid electrolyte 106 can include NaₓLi₃₋ₓYCl₆ (0<x<3), optionally provided in a trigonal ordered crystal structure. The NaₓLi₃₋ₓYCl₆ (0<x<3) can exhibit characteristics beneficial for solid-state battery electrolyte applications. Such characteristics include, for example, effective ionic conductivity (including room temperature conductivity), formability/ductility, oxidation/reduction stability, and compatibility with anode and cathode materials.

The materials used in the electrodes can include any suitable electrode materials or combinations thereof known in the art for use in solid-state lithium-ion batteries. Example anode materials include lithium metal, Li—In alloy, lithium titanate (e.g., oxides such as Li₄₋₇Ti₅O₁₂), other metal oxides (e.g., SnO₂, TiO₂), carbon materials (e.g., graphite, carbon nanotubes, graphene), silicon, and combinations thereof. Example cathode materials include various metal oxides (e.g., LiCoO₂, LiNiO₂, LiMn₂O₄, lithium nickel manganese cobalt oxides (NMCs) such as LiNiₓMn_{y}Co_{1-x-y}O₂, and lithium nickel cobalt aluminum oxides (NCAs) such as LiNiₓAl_{y}Co_{1-x-y}O₂), sulfur-based materials (e.g., Li₂S), phosphate-based materials (e.g., LiFePO₄), and combinations thereof.

Because the solid electrolyte NaₓLi₃₋ₓYCl₆ (0<x<3) can conduct lithium ions and sodium ions, it can be utilized as an effective solid electrolyte in solid-state lithium-ion batteries and/or in solid-state sodium-ion batteries. Sodium-ion batteries do not typically provide the same energy density as lithium-ion batteries. However, sodium-ion batteries can be more sustainable and cost-effective for certain applications, particularly where the lower energy density can be adequately compensated by larger battery sizes.

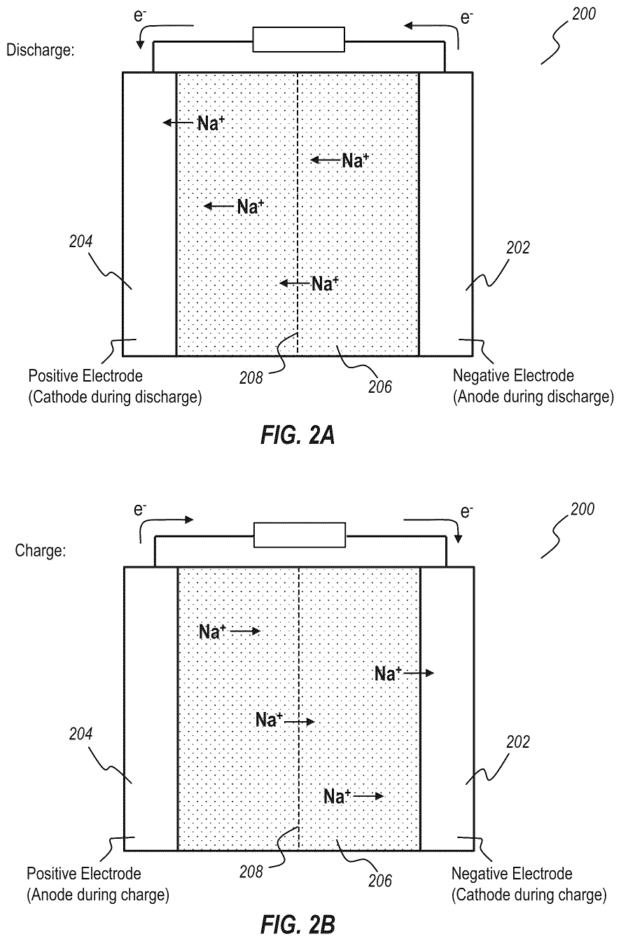

FIG. 2A is a schematic view of an example solid-state sodium-ion battery during discharge, and FIG. 2B is a schematic view of the example solid-state sodium-ion battery during charge.

As shown in FIG. 2A, the oxidation half reaction occurs at the negative electrode 202, generating sodium ions and electrons. The generated sodium ions pass through the solid electrolyte 206 toward the positive electrode 204. At the positive electrode 204, the sodium ions combine with the electrons in the reduction half reaction. The battery 200 can also include a separator 208, though in some embodiments the separator 208 can be omitted because the electrolyte 206 is solid.

During charge, materials at the positive electrode 204 are oxidized to generate sodium ions and electrons. The generated sodium ions pass through the solid electrolyte 206 toward the negative electrode 204. At the negative electrode 202, the sodium ions combine with the electrons in the reduction half reaction.

The solid electrolyte 206 can include NaₓLi₃₋ₓYCl₆ (0<x<3), optionally provided in a trigonal ordered crystal structure. The NaₓLi₃₋ₓYCl₆ (0<x<3) can exhibit characteristics beneficial for solid-state battery electrolyte applications. Such characteristics include, for example, effective ionic conductivity (including room temperature conductivity), formability/ductility, oxidation/reduction stability, and good compatibility with anode and cathode materials.

The materials used in the electrodes can include any suitable electrode materials or combinations thereof known in the art for use in solid-state sodium-ion batteries. Example anode materials include sodium metal, sodium metal alloys (e.g., Na—K, Na—Pb), carbon materials (e.g., hard carbon, graphite, carbon nanotubes, graphene, carbon arsenide), tin-based materials, sulfides (e.g., MoS₂, TiS₂), sodium titanate (e.g., oxides such as Na₂Ti₃O₇), and combinations thereof. Example cathode materials include various metal oxides (e.g., NaCoO₂, NaNiO₂, NaMn₂O₄), sulfur-based materials (e.g., Na₂S), phosphate-based materials (e.g., NaFePO₄, Na₂FeP₂O₇, or Na₃V₂(PO₄)₃), and combinations thereof.

The batteries 100 and 200 can also include a container (not shown). The container can be any container suitable for the intended application of the solid-state battery. The container can include metal (e.g., stainless steel, aluminum) and/or polymer materials. The container functions as a physical housing or casing to hold the anode, cathode, and electrolyte in proper position, and to provide mechanical support, electrical insulation, and/or thermal insulation.

The container can also include current collectors to collect and distribute electrical current from the anode and cathode to an external circuit. The current collectors may be formed of conductive materials such as copper or aluminum. The container can further include various sealing and/or barrier materials to prevent the ingress of moisture or contaminants. The container can further include various insulating layers (e.g., formed from ceramics and/or glass) for electrical insulation of the internal components. The container can further include various components for managing thermal loads and preventing overheating, such as heat sink components, thermal interface materials, and thermal insulators.

The solid electrolyte of the solid-state battery can also include one or more dopants. The one or more dopants can be added to improve ionic conductivity of the electrolyte, modify vacancies in the electrolyte, influence the crystal structure of the electrolyte, promote structural stability of the electrolyte, promote thermal stability of the electrolyte, and/or affect grain boundaries within the electrolyte. Example dopants include La, Ca, Ni, Co, Gd, Pr, Mg, Al, and Sr. One or more dopants directed to the Y site may be additionally or alternatively included. Such dopants may include, for example, Zr, Ti, Si, Ge, and/or Sn.

### Compound Synthesis

NaₓLi₃₋ₓYCl₆ (0<x<3) compounds can be synthesized using methods known in the art for synthesizing alkali metal and rare-earth metal halides. That is, the skilled person can readily adapt known synthesis methods for other alkali metal and rare-earth metal halides to the compounds disclosed herein.

See, for example: the solid-state synthesis reaction described by Ito et al. “Kinetically Stabilized Cation Arrangement in Li3YCl6 Superionic Conductor during Solid-State Reaction” (Adv. Sci. 2021, 8, 210413); the wet chemistry method described by Wang et al. “A universal wet-chemistry synthesis of solid-state halide electrolytes for all-solid-state lithium-metal batteries” (Science Advances 2021, vol. 7, issue 37); the solid-state and mechanochemical synthesis methods described by Schlem et al. “Insights into the Lithium Sub-structure of Superionic Conductors Li3YCl6 and Li3YBr6” (Chem. Mater. 2021, 33, 1, 327-37); and/or the synthesis described by Hu et al. “Revealing the Pnma crystal structure and ion-transport mechanism of the Li3YCl6 solid electrolyte” (Cell Reports Physical Science 4, 101428).

Generally, synthesis of the disclosed compound can be carried out by mixing stoichiometrically appropriate amounts of suitable precursor components (e.g., NaCl, LiCl, and YCl₃). The precursor mixture can be subjected to mechanical processing, such as ball milling and/or other suitable processing techniques (e.g., attrition milling, jet milling, vibration milling, hammer milling, roller milling, colloid milling, cryogenic milling, ultrasonic milling, pin milling, and/or manual techniques such as mortar and pestle grinding). Optionally, a suitable volatile organic liquid, such as acetone and/or an alcohol, may be added to the mixture to aid in homogenization.

Subsequently, the processed precursor mixture can be subjected to heat treatment to initiate and carry out the solid-state reaction. The heat treatment can be carried out in an appropriate container formed from materials that are substantially chemically inert to the reactants at the heating temperatures used. Example materials include suitable metals such as noble metals. The processed precursor material may optionally be pelletized prior to heat treatment.

The heat treatment may be carried out at a temperature and time sufficient to carry out the solid-state reaction. During synthesis of Na₂LiYCl₆, a temperature of 627° C. was beneficially found to provide a single phase of trigonal ordered Na₂LiYCl₆, whereas a lower temperature of 277° C. included an LiCl phase. The heat treatment temperature may therefore be carried out at a temperature of 300° C. or more, 400° C. or more, 500° C. or more, 600° C. or more, such as up to 700° C., 800° C., 900° C., or 1,000° C., or may be carried out at a temperature within a range with endpoints defined by any two of the foregoing values.

Following heat treatment, the material may undergo further mechanical processing, such as undergoing any one or more of the mechanical processing techniques recited above.

The resulting product may be analyzed using analytical methods known in the art. Examples include X-ray diffraction (XRD), scanning electron microscopy (SEM), transmission electron microscopy (TEM), atomic force microscopy (AFM), nuclear magnetic resonance (NMR) spectroscopy, Fourier transform infrared (FTIR) spectroscopy, Raman spectroscopy, differential scanning calorimetry (DSC), X-ray photoelectron spectroscopy (XPS), and electron paramagnetic resonance (EPR).

### Battery Manufacture & Use

A method of manufacturing a solid-state battery, such as a solid-state lithium-ion battery or a solid-state sodium-ion battery can include: placing a positive electrode within a container; placing a negative electrode within the container; and placing a solid electrolyte within the container between and in conductive contact with the positive electrode and the negative electrode, wherein the solid electrolyte comprises NaₓLi₃₋ₓYCl₆ (0<x<3). The solid electrolyte optionally comprises a trigonal ordered crystal structure.

The container can be any container suitable for the intended application of the solid-state battery. The container functions as a physical housing or casing to hold the anode, cathode, and electrolyte in proper position, and to provide mechanical support, electrical insulation, and/or thermal insulation. The container can include any of the components as described elsewhere herein.

The solid-state batteries may be used in any application amenable to battery power. Examples include consumer electronic devices such as laptop computers, mobile phones, and tablets; wearable devices such as smart watches and other fitness tracking devices; implantable medical devices such as pacemakers and neurostimulators; electric vehicles (e.g., cars, bikes, scooters), unmanned aerial vehicles (UAVs) including drones, grid and/or renewable (e.g., solar, wind) excess energy storage, electric tools, and any other application where battery power is suitable.

### EXAMPLES

Example 1 describes a synthesis process from which Na₂LiYCl₆ was generated and details characterization and conductivity testing. Examples 2-5 are prophetic examples intended to illustrate the expected characteristics and benefits of NaₓLi₃₋ₓYCl₆ (0<x<3) when used as a solid-state battery electrolyte. The prophetic results described below are reasonably expected based on the contents of the present disclosure.

### Example 1—NaₓLi₃₋ₓYCl₆ Synthesis & Characterization

Synthesis Procedure: All fabrication processes were conducted in an Ar-filled glovebox (VAC) (<0.5 ppm O₂, 0.5 ppm moisture). Stoichiometric amounts of the precursors NaCl (Sigma Aldrich, ≥99%), LiCl (Sigma Aldrich, ≥99%), and YCl₃ (Sigma Aldrich, 99.99%) were hand-mixed in an agate mortar for 30 minutes. One gram of the mixture was pressed into a pellet with diameter of 12 mm under a pressure of 200 bar using a hydraulic press. The pellet was then loaded into a quartz ampoule and flame sealed under vacuum. The sealed ampoules with a pellet were heated using a tube furnace, with a ramp rate of 10° C. per minute to a temperature of 450° C. to 550° C. depending on the stoichiometry of the sample, and held at this temperature for 5 h. The sample was then cooled down naturally. Once cooled, the sample ampoules were carefully opened in a glovebox, finely ground with a mortar and pestle, and then characterized. All products remained in the glovebox while handling.

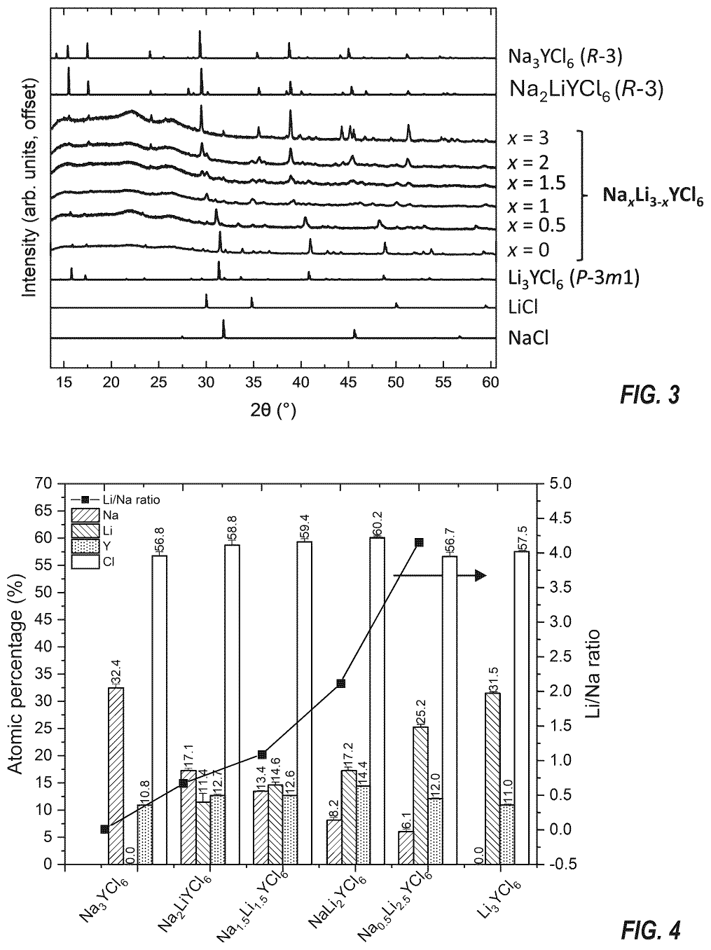

XRD Characterization: powder XRD measurements were conducted on a Rigaku SmartLab SE Bragg-Brentano diffractometer with a Cu source (λ=1.5418 Å) and D/teX Ultra 250 1D high-speed position-sensitive detector. Samples were placed in a SiO₂ zero background well holder then covered with a single layer of Kapton tape inside a glovebox to avoid moisture degradation. The diffraction pattern of synthesized Na₂LiYCl₆ matched with the predicted structure in the Na₃YCl₆ R3̅ phase, as show in FIG. 3. The powder XRD diffraction patterns revealed that trigonal Na₃ YCl₆ with space group R3̅ was the major phase observed for x=1.5 to 3, while trigonal Li₃YCl₆ with space group P3̅m1 was the major phase for x=0 to 0.5.

Elemental Analysis: XPS was used to confirm the atomic percentage of Li, Na, Y, and Cl in the NaₓLi₃₋ₓYCl₆ samples. For x from 0 to 3, the Li/Na ratio matches qualitatively with the nominal values from the compositions. For XPS, the NaₓLi₃₋ₓYCl₆ (100 mg) fine powder was compacted into a pellet via a hydraulic press (100 bar) in stainless steel pressure dies inside an Ar-filled glovebox. The pellets were then loaded onto sample holder and transferred to an XPS analysis chamber without exposing to air. XPS analysis was performed using a Kratos Axis Ultra DLD spectrometer, which consists of an Al Kα monochromatic X-ray source (1486.6 eV) and a high-resolution spherical mirror analyzer. X-ray source was operated at 150 W power and the emitted photoelectrons were collected at the analyzer entrance slit normal to the sample surface. The high-resolution spectra were collected at a pass energy of 40 eV with a step sized of 0.1 eV. XPS spectra were calibrated using C 1s signal at 285 eV. Data were processed using CasaXPS software. The Li 1s, Na 2s, Y 3d, and Cl 2p high resolution spectra were used to calculate the composition of the samples. FIG. 4 shows atomic percentages of Na, Li, Y, and Cl from the XPS analysis.

SEM and energy-dispersive X-ray spectroscopy (EDS) confirmed the relative elemental ratios of Na, Y, and Cl for the bulk of the samples. Since Li is a light element, it cannot be detected by EDS. Therefore, only relative ratios of the non-Li elements are determined via this technique. Powders of sample were pressed into a flat, thin pellet and placed onto a conductive double-sided carbon adhesive dot placed on an aluminum stub. An electron beam at 20 kV accelerating voltage with 1.6 nA current was used with a working distance of 10 mm. At least 10 different sites on each pellet of different compositions (NaₓLi₃₋ₓYCl₆; x=0, 0.5, 1, 1.5, 2, 3) were measured for average statistics of the elemental quantification.

Ion Conductivity Characterization: 110 mg of fine electrolyte powder were loaded into a Split Cell (MSE Supplies) with a diameter of 12 mm and sandwiched between 2 stainless steel electrodes. The cell was then cold-pressed at 100 bars using a hydraulic press inside an Ar-filled glovebox. The cell was then removed from the glovebox and loaded into a pressure jig and pressurized to 250 MPa. Impedance measurements were taken with an applied AC potential of 100 mV over a frequency range of 1 MHz to 100 mHz using Biologic VMP3. The EIS were collected at various temperatures between 100° C. and 25° C. At each temperature, the cell was rested for 2 h prior to collecting the EIS spectra. The thickness of each pellet was measured after completing impedance measurement using a digital micrometer (Mitutoyo). The ionic conductivity of the pelletized electrolyte was determined using the EIS data.

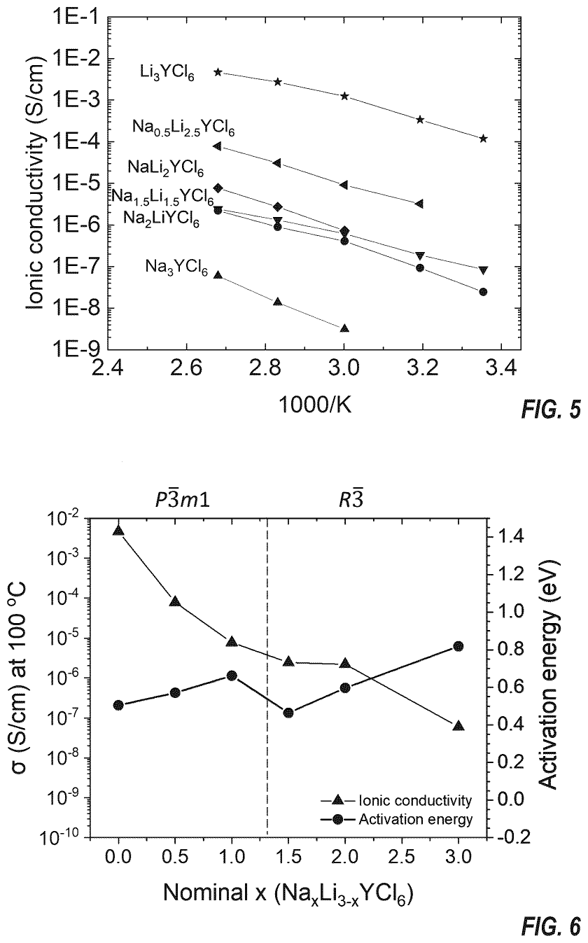

Ionic conductivities of NaₓLi₃₋ₓYCl₆ measured at different temperatures are shown in FIG. 5. The introduction of Li in place of Na boosted the ionic conductivity by more than two orders of magnitude, specifically at a substitution level of one third, exemplified by Na₂LiYCl₆ (x=2) exhibiting a conductivity of 2.2×10⁻⁶ S/cm at 100° C., compared to the meager 6.0×10⁻⁸ S/cm at 100° C. observed in the parent Na₃ YCl₆ material. The measured ionic conductivities across varying x values consistently depict the rising trend associated with increased Li content. This trend implies that the heightened mobility of Li+ ions actively contributes to the measured conductivity within these substituted compositions.

As shown in FIG. 6, a significant reduction of activation energy was also observed with the introduction of lithium (x=0.5 to 3) compared to the parent Na₃YCl₆ (0.82 eV). Notably, Na₂LiYCl₆ (with a similar R3̅ crystal structure as parent Na₃ YCl₆) displays a significantly lower activation energy (Ea=0.6 eV), indicating an amplified ionic diffusion process.

This enhancement in conductivity and reduction in activation energy can likely be attributed to the involvement of Li+ ions in ionic transportation, as well as potential alterations in the crystal structure, such as expansion of ion diffusion channels and local structural disorder resulting from Li+ substitution. The trigonal crystal structure of parent Na3YCl6 contains one fully occupied and two partially occupied Na sites, enabling diffusion pathways through and between channels, predominantly facilitating ionic conduction along the c-axis [38]. The heightened conductivity observed upon lithium substitution suggests that the evolving occupancy and distribution of Na and Li sites potentially modulate the energy landscape along the c-axis, thereby fostering accelerated ionic diffusion.

### Example 2—Stability Analysis

Stability testing of Na₂LiYCl₆ is carried out using differential scanning calorimetry (DSC) or similar technique to characterize the material in an inert environment and in one or more environments that will inform material stability in the presence of oxygen and water vapor. It is expected that the Na₂LiYCl₆ material will exhibit effective stability in such environments, and with other portions of the battery (anode and cathode), at least comparable to previously known solid-state electrolyte materials.

### Example 3—Additional Conductivity Analysis

Conductivity analysis of Na₂LiYCl₆ is carried out and includes: variable temperature AC impedance analysis with a two/three electrode setup to distinguish bulk/grain boundary contributions; variable temperature DC resistance analysis to gain transference number; and solid state nuclear magnetic resonance (NMR) spectroscopy for selected samples to obtain ion diffusion constants. The Na₂LiYCl₆ is expected to exhibit effective lithium and sodium conductivity.

### Example 4—Electrochemical Properties

Electrochemical properties characterization is carried out and includes: electrochemical impedance spectroscopy measurements and conductivity fitting over a range of temperatures; testing the material in a coin cell with a lithium metal or graphite anode and an NMC cathode (up to 100 cycles); and postmortem analysis using infrared (IR), XPS and Raman spectroscopy of coin cells to evaluate electrochemical stability and failure mode predictions. The Na₂LiYCl₆ electrolyte material is expected to exhibit effective electrochemical properties.

### Example 5—Interface Testing

Test half-cells are formed by coupling the Na₂LiYCl₆ electrolyte to a lithium metal anode to determine stability of the electrode-electrolyte interface. It is expected that the Na₂LiYCl₆ electrolyte will be capable of forming and maintaining an effective interface, at least comparable to previously known solid-state electrolyte materials.

### Additional Terms & Definitions

All publications (including patents, patent applications, journal articles, etc.) recited herein are incorporated herein by reference.

The embodiments disclosed herein should be understood as comprising/including disclosed components and may therefore include additional components not specifically described. Optionally, the embodiments disclosed herein are essentially free or completely free of components that are not specifically described. That is, non-disclosed components may optionally be completely omitted or essentially omitted from the disclosed embodiments.

For example, a solid-state battery including a solid electrolyte that comprises NaₓLi₃₋ₓYCl₆ (0<x<3) may essentially omit or completely omit other electrolyte compounds not specifically disclosed herein, including any electrolyte with a different compound formula and/or any electrolyte with a different crystalline structure (e.g., any electrolyte with a non-trigonal crystalline structure). Similarly, the disclosed solid-state electrolyte may essentially omit or completely omit one or more elements not specifically disclosed as being part of the electrolyte compound. For example, the disclosed solid-state electrolyte may essentially omit or completely omit one or more of Be, Sc, Cs, Rb, Zr, Ti, Hf, Ta, Ca, Sr, Mg, or Fe.

An embodiment that “essentially omits” a component may include trace amounts and/or non-functional amounts of the component. For example, an “essentially omitted” component may be included in an amount no more than 1%, no more than 0.5%, no more than 0.1%, or no more than 0.01% by total weight of the composition. This is likewise applicable to other negative modifier phrases such as “essentially without,” “essentially free of,” similar phrases using “substantially” or other synonyms of “essentially,” and the like.

A composition that “completely omits” a component does not include a detectable amount of the component (i.e., does not include an amount above any inherent background signal associated with an appropriate testing instrument) when analyzed using standard compositional analysis techniques such as, for example, microscopy imaging techniques, chromatographic techniques (e.g., thin-layer chromatography (TLC), gas chromatography (GC), liquid chromatography (LC)), or spectroscopy techniques (e.g., Fourier transform infrared (FTIR) spectroscopy).

In addition, unless otherwise indicated, numbers expressing quantities, constituents, distances, or other measurements used in the specification and claims are to be understood as optionally being modified by the term “about.” When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A solid-state battery, comprising:
an anode;
a cathode; and
a solid electrolyte disposed between and in conductive contact with the anode and the cathode, wherein the solid electrolyte comprises
NaₓLi₃₋ₓYCl₆,
wherein x is greater than 0 and less than 3.

2. The solid-state battery of claim 1, wherein the NaₓLi₃₋ₓYCl₆ includes a trigonal ordered crystal structure.

3. The solid-state battery of claim 1, wherein the solid-state battery is a solid-state lithium-ion battery.

4. The solid-state battery of claim 3, wherein the anode comprises one or more of lithium metal, Li—In alloy, a lithium metal oxide, carbon materials, or silicon.

5. The solid-state battery of claim 4, wherein the lithium metal oxide comprises one or more of lithium titanate, tin oxide, or titanium oxide.

6. The solid-state battery of claim 4, wherein the carbon materials comprise one or more of graphite, carbon nanotubes, or graphene.

7. The solid-state battery of claim 3, wherein the cathode comprises one or more of a metal oxide, a sulfur-based material, or a phosphate-based material.

8. The solid-state battery of claim 7, wherein the metal oxide includes one or more of a cobalt oxide, nickel oxide, manganese oxide, nickel manganese cobalt oxide, or nickel cobalt aluminum oxide.

9. The solid-state battery of claim 1, wherein the solid-state battery is a solid-state sodium-ion battery.

10. The solid-state battery of claim 9, wherein the anode comprises one or more of sodium metal, a sodium metal alloy, a carbon material, a tin-based material, a sulfide, or sodium titanate.

11. The solid-state battery of claim 10, wherein the sodium metal alloy comprises one or more of Na—K or Na—Pb.

12. The solid-state battery of claim 10, wherein the carbon material comprises one or more of hard carbon, graphite, carbon nanotubes, graphene, or carbon arsenide.

13. The solid-state battery of claim 9, wherein the cathode comprises one or more of a metal oxide, a sulfur-based material, or a phosphate-based material.

14. The solid-state battery of claim 13, wherein the metal oxide comprises one or more of a cobalt oxide, nickel oxide, manganese oxide, nickel manganese cobalt oxide, or nickel cobalt aluminum oxide.

15. The solid-state battery of claim 1, wherein the battery is configured for powering a consumer electronic device, a wearable device, an implantable medical device, an electric vehicle, an unmanned aerial vehicle (UAV), an electric tool, or for grid and/or excess renewable energy storage.

16. The solid-state battery of claim 1, wherein the solid electrolyte comprises one or more of Na₂LiYCl₆, NaLi₂YCl₆, Na_{0.5}Li_{2.5}YCl₆, Na_{1.5}Li_{1.5}YCl₆, or Na_{2.5}Li_{0.5}YCl₆.

17. A method of manufacturing a solid-state battery, comprising:
placing a positive electrode within a container;
placing a negative electrode within the container; and
placing a solid electrolyte within the container between and in conductive contact with the positive electrode and the negative electrode,
wherein the solid electrolyte comprises
NaₓLi₃₋ₓYCl₆,
wherein x is greater than 0 and less than 3.

18. The method of claim 17, wherein the NaₓLi₃₋ₓYCl₆ comprises a trigonal ordered crystal structure.

19. The method of claim 17, wherein the solid-state battery is configured as a lithium-ion battery.

20. The method of claim 17, wherein the solid-state battery is configured as a sodium-ion battery.
